(19) United States
(12) Patent Application Publication
(10) Pub. No.: US 2025/0314600 A1
(43) Pub. Date: Oct. 9, 2025

(54) ELECTRONIC DEVICE FOR DETECTING AND CLASSIFYING DEFECT OF WAFER AND METHOD OF OPERATING THE SAME

(71) Applicants: SAMSUNG ELECTRONICS CO., LTD., Suwon-si (KR); IUCF-HYU (INDUSTRY-UNIVERSITY COOPERATION FOUNDATION HANYANG UNIVERSITY), Seoul (KR)

(72) Inventors: SEUNGJU HAN, Suwon-si (KR); SANG HYUK MOON, Seoul (KR); TaeKyeong PARK, Seoul (KR); Je Hyeong HONG, Seoul (KR)

(73) Assignees: SAMSUNG ELECTRONICS CO., LTD., Suwon-si (KR); IUCF-HYU (INDUSTRY-UNIVERSITY COOPERATION FOUNDATION HANYANG UNIVERSITY), Seoul (KR)

(21) Appl. No.: 19/056,033

(22) Filed: Feb. 18, 2025

(30) Foreign Application Priority Data
Apr. 9, 2024 (KR) 10-2024-0048252

(51) Int. Cl. G01N 21/88; G01N 21/17; G01N 21/95; G06T 7/00; G06T 7/73

(52) U.S. Cl. CPC G01N 21/8851; G01N 21/9501; G06T 7/0008; G06T 7/75; G01N 2021/1765; G01N 2021/8854; G01N 2021/8887; G01N 2201/1247; G06T 2207/20021; G06T 2207/20212; G06T 2207/30148

(57) ABSTRACT

An electronic device for detecting and classifying a defect of a wafer and a method of detecting and classifying a defect of a wafer are provided. The method includes obtaining an image of a wafer, dividing the image into a plurality of patches and extracting first features from the plurality of patches, selecting a target feature group from a plurality of feature groups, based on the first features, determining whether a defect exists in the wafer, based on the target feature group and the first features, and when the defect exists in the wafer, determining a defect type of the defect, wherein the plurality of feature groups is obtained through clustering based on second features extracted from a plurality of normal images.

### CROSS-REFERENCE TO RELATED APPLICATION

This application is based on and claims priority from Korean Patent Application No. 10-2024-0048252, filed on Apr. 9, 2024, in the Korean Intellectual Property Office, the entire disclosure of which is incorporated herein by reference for all purposes.

### BACKGROUND

### 1. Field

Embodiments of the disclosure relate to an electronic device for detecting and classifying a defect of a wafer and a method for detecting and classifying a defect of a wafer.

### 2. Description of the Related Art

In semiconductor processing technology, defect detection and defect classification of high accuracy may be required to increase wafer throughput. For example, in order to guarantee quality of a semiconductor and reduce costs, it may be necessary to determine defects in wafers for which a process has been completed. Various inspections such as visual inspection, mechanical inspection, and electrical inspection may be used to determine defects on a wafer. Recently, a method of determining defects by inputting an image of a wafer into a trained machine learning model is being attempted and researched.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a method including: obtaining a first image of a wafer, dividing the first image into a plurality of patches, extracting one or more first features from the plurality of patches, obtaining a plurality of feature groups by clustering one or more second features extracted from a plurality of second images, selecting a target feature group from the plurality of feature groups, based on the one or more first features, determining whether a defect is present in the wafer, based on the target feature group and the one or more first features, and determining a defect type of the defect based on the defect being present in the wafer.

The selecting of the target feature group from the plurality of feature groups may include: calculating an average feature of each of the plurality of feature groups; and selecting the target feature group based on the one or more first features and the average feature of each of the plurality of feature groups.

The selecting of the target feature group may include: calculating a distance between the one or more first features and the average feature of each of the plurality of feature groups, and selecting, as the target feature group, a feature group in which the distance between the one or more first features and the average feature is a minimum.

The determining of whether the defect is present in the wafer may include: determining a closest feature, which is a feature closest to one of the one or more first features among features of the target feature group; and determining that the defect is present in the wafer based on a defect score corresponding to one of the one or more first features and the closest feature is greater than a threshold value.

The threshold value may be obtained based on a plurality of augmented images and the plurality of second images, and the plurality of augmented images may be obtained based on the plurality of second images and previously obtained defect images.

The determining of the defect type of the defect may include inputting the first image into a defect classification model trained based on the plurality of second images and a plurality of augmented images to determine the defect type of the defect, and the plurality of augmented images is obtained based on the plurality of second images and previously obtained defect images.

The determining of the plurality of feature groups may include: dividing each of the plurality of second images in a plurality of patches; extracting the one or more second features from the plurality of patches; and determining the plurality of feature groups by clustering the one or more second features.

The method may further include determining a threshold value to determine whether the defect is present based on the plurality of feature groups.

The determining of the threshold value may include extracting defect portions from previously obtained defect images; generating combined images by combining the plurality of second images with the defect portions; generating a plurality of augmented images by augmenting the combined images; and determining the threshold value based on the plurality of augmented images.

According to another aspect of the disclosure, there is provided a non-transitory computer-readable storage medium storing instructions that, when executed by a processor, cause the processor to perform the method.

According to another aspect of the disclosure, there is provided a method including: determining a plurality of feature groups, based on a plurality of first images; obtaining a plurality of augmented images based on the plurality of first images and previously obtained defect images; obtaining a second image for a wafer; determining a threshold value of a defect detection model for detecting a defect in the wafer included in the second image, based on the plurality of first images and the plurality of augmented images; determining whether the defect is present in the wafer by inputting the second image into the defect detection model for detecting the defect based on the threshold value; and determining a defect type of the defect by inputting the second image into a defect classification model based on the defect being present.

The method may further include generating the plurality of augmented images based on the plurality of first images, wherein the generating of the plurality of augmented images may include: extracting defect portions from the previously obtained defect images; generating combined images by combining the plurality of first images with the defect portions; and generating the plurality of augmented images by augmenting the combined images.

The determining of the threshold value may include determining, as the threshold value, a value with a highest detection rate for an image of a wafer in which a defect is present based on the plurality of augmented images and the plurality of first images input to the defect detection model.

The determining of whether the defect is present may include: dividing the second image into a plurality of patches; extracting one or more first features from the plurality of patches; selecting a target feature group from a plurality of feature groups obtained based on the plurality of first images, based on the one or more first features; and determining whether the defect is present in the wafer, based on the target feature group and the one or more first features.

The selecting of the target feature group from the plurality of feature groups may include: calculating a distance between the one or more first features and an average feature of each of the plurality of feature groups and selecting a feature group in which the distance is a minimum as the target feature group.

The determining of whether the defect is present may include: determining a closest feature, which is a feature closest to one of the one or more first features among features of the target feature group; and determining that the defect is present in the wafer based on a defect score corresponding to one of the one or more first features and the closest feature being greater than the threshold value.

According to another aspect of the disclosure, there is provided an electronic device including: a processor configured to: obtain a first image of a wafer; divide the first image into a plurality of patches; extract one or more first features from the plurality of patches; obtain a plurality of feature groups by clustering one or more second features extracted from a plurality of second images; select a target feature group from the plurality of feature groups, based on the one or more first features; determine whether a defect is present in the wafer, based on the target feature group and the one or more first features; and determine a defect type of the defect based on the defect being present in the wafer.

The processor may be further configured to: calculate an average feature of each of the plurality of feature groups, and select the target feature group based on the one or more first features and the average feature of each of the plurality of feature groups.

The processor may be further configured to: determine a closest feature, which is a feature closest to one of the one or more first features among features included in the target feature group, and determine that the defect is present in the wafer based on a defect score corresponding to one of the one or more first features and the closest feature is greater than a threshold value.

The processor may be further configured to input the first image into a defect classification model trained based on the plurality of second images and a plurality of augmented images to classify the defect type of the defect, and the plurality of augmented images is obtained based on the plurality of second images and previously obtained defect images.

Additional aspects of embodiments will be set forth in part in the description which follows and, in part, will be apparent from the description, or may be learned by practice of the disclosure.

### BRIEF DESCRIPTION OF DRAWINGS

The above and/or other aspects will be more apparent by describing certain embodiments with reference to the accompanying drawings, in which:

FIG. 1 is a diagram illustrating an electronic device according to an embodiment;

FIG. 2 is a flowchart illustrating a method of operating an electronic device, according to an embodiment;

FIGS. 3 and 4 are diagrams illustrating a method of detecting a defect, according to an embodiment;

FIGS. 5 and 6 are diagrams illustrating a method of determining a plurality of feature groups, according to an embodiment;

FIG. 7 is a diagram illustrating a method of augmenting an image, according to an embodiment; and

FIG. 8 is a diagram illustrating a defect classification model according to an embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

The embodiments of the disclosure are example embodiments, and thus, the disclosure is not limited thereto and may be realized in various other forms. As is traditional in the field, embodiments may be described and illustrated in terms of blocks, as shown in the drawings, which carry out a described function or functions. These blocks, which may be referred to herein as “units” or “modules” or the like, or by names such as device, logic, circuit, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Unless otherwise defined, all terms, including technical and scientific terms, used herein have the same meaning as commonly understood by one of ordinary skill in the art to which the disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. In the description of the embodiments with reference to the accompanying drawings, like reference numerals refer to like components and a repeated description related thereto will be omitted.

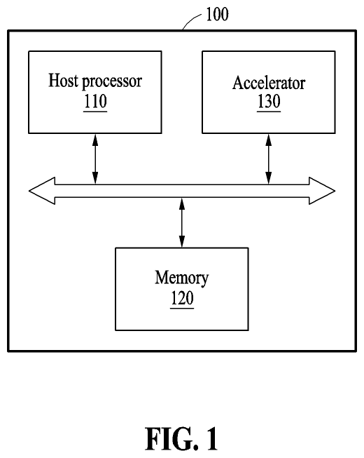

FIG. 1 is a diagram illustrating an electronic device according to an embodiment.

Referring to FIG. 1, an electronic device 100 may include a processor 110 and a memory 120. According to an embodiment, the electronic device 100 may further include an accelerator 130. The processor 110, the memory 120, and the accelerator 130 may communicate with one another through a communication interface. For example, the communication interface may include, but is not limited to, a bus, a network on a chip (NoC), or a peripheral component interconnect express (PCIe). Components related to embodiments herein are only included in the electronic device 100 illustrated in FIG. 1. However, the disclosure is not limited thereto, and as such, the electronic device 100 may include one or more other components. For example, the electronic device 100 may also include other general-purpose components in addition to the components illustrated in FIG. 1.

According to an embodiment, the processor 110 may perform one or more operations of the electronic device 100. For example, the processor 110 may perform overall functions or operations for controlling the electronic device 100. The processor 110 may generally control the electronic device 100 by executing programs and/or instructions stored in the memory 120. The processor 110 may be implemented as a central processing unit (CPU), a graphics processing unit (GPU), or an application processor (AP), which is included in the electronic device 100, but embodiments are not limited thereto.

The memory 120 may be hardware for storing data having been processed or to be processed by the electronic device 100. In addition, the memory 120 may store an application, a driver, and the like to be driven by the electronic device 100. The memory 120 may include a volatile memory and/or a non-volatile memory. For example, the volatile memory may include, but is not limited to, a dynamic random-access memory (DRAM).

The electronic device 100 may include the accelerator 130 for performing one or more operations. According to an embodiment, the processor 110 may be a host processor, for example, a general-purpose host processor. According to an embodiment, the accelerator 130 may be a specialized processor or a special-purpose processor. For example, the accelerator 130 may process tasks that may be more efficiently processed by a separate exclusive processor, rather than by a general-purpose host processor (e.g., the processor 110), due to the characteristics of the operation. In this case, one or more processing elements included in the accelerator 130 may be used. The accelerator 130 may include, but is not limited to, a neural processing unit (NPU), a tensor processing unit (TPU), a digital signal processor (DSP), a GPU, a neural engine, and the like that may perform an operation according to a neural network.

According to an embodiment, a processor to be described below may be implemented as the accelerator 130, but the disclosure is not limited thereto. The processor may also be implemented as the processor 110.

The electronic device 100 may obtain an image of a wafer. The image may include at least a portion of the wafer. The electronic device 100 may determine whether a defect exists in the image. For example, the electronic device 100 may determine or detect whether a defect is present in the image. For example, the electronic device 100 may determine whether a defect exists in at least a portion of the wafer included in the image. In an example case in which the electronic device 100 determines that a defect exists, the electronic device 100 may determine classification of the defect. For example, based on a detections of a defect, the electronic device 100 may determine classification of the defect.

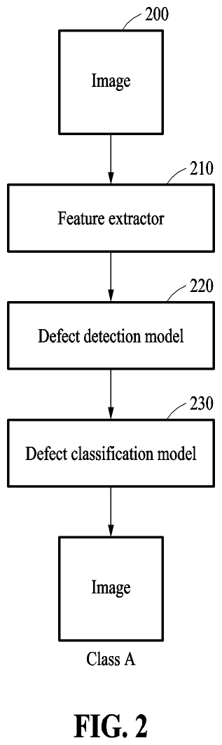

FIG. 2 is a flowchart illustrating a method of operating an electronic device, according to an embodiment.

According to an embodiment, the method may include obtaining an image 200. For example, the electronic device may obtain an image 200 of a wafer. The image 200 of the wafer may be an image including at least a portion of the wafer. For example, the image 200 may be an image captured by magnifying at least a portion of the wafer at high magnification. The image 200 may be an image that is a subject for defect detection and may be referred to as a target image.

According to an embodiment, the method may include inputting the image 200 to a feature extractor 210. For example, the electronic device may input the image of the wafer to a feature extractor 210. According to an embodiment, the method may include dividing the image 200 of the wafer into a plurality of patches. For example, the electronic device may divide the image 200 of the wafer into a plurality of patches and may input the image 200 to the feature extractor 210. However, the disclosure is not limited thereto, and as such, according to another embodiment, the feature extractor 210 may divide the image 200 of the wafer into a plurality of patches. For example, the method may include inputting the image 200 200 to the feature extractor 210 and the feature extractor 210 may divide the image 200 of the wafer into a plurality of patches

According to an embodiment, the method may include extracting a feature from the plurality of patches. For example, the feature extractor 210 may extract a feature from each of the plurality of patches. According to an embodiment, the feature extractor 210 may be a neural network model. For example, the feature extractor 210 may be a neural network model previously trained to extract a feature from an image.

According to an embodiment, the method may include inputting the extracted features to a defect detection model 220. For example, the electronic device may input the features extracted by the feature extractor into the defect detection model 220. According to an embodiment, the method may include determining that a defect exists (or a defect is present) in the wafer based on the extracted features. For example, the defect detection model 220 may be a model trained to determine whether a defect exists in at least a portion of the wafer included in the image 200 based on the features being input to the defect detection model 220. For example, when the features are input to the defect detection model 220, the defect detection model 220 may be a model trained to determine whether a defect exists in at least a portion of the wafer included in the image 200.

According to an embodiment, the method may include outputting a defect segmentation image based on a determination that a defect is present in the wafer. In an example case in which the defect detection model 220 determines that a defect exists (or a defect is present) in the wafer, the defect detection model 220 may output a defect segmentation image. The defect segmentation image may be an image in which a defect portion of the image 200 is emphasized.

According to an embodiment, the method may include inputting the image 200 into the defect classification model 230. For example, based on a determination that a defect exists in the wafer, the image 200 may be into a defect classification model 230. In an example case in which it is determined that there exists a defect in at least a portion of the wafer included in the image 200, the electronic device may input the image 200 into a defect classification model 230. For example, when the electronic device determines that a defect is present in at least a portion of the wafer included in the image 200, the electronic device may input the image 200 into a defect classification model 230. The defect classification model 230 may be a model trained to determine classification of the defect present in at least a portion of the wafer included in the image 200. For example, the image 200 may be received as input into the defect classification model 230. The defect classification model 230 may be a model trained based on augmented images. For example, the defect classification model 230 may classify the defect present in at least a portion of the wafer included in the image 200 as class A.

For example, as described above, the electronic device may provide a framework in which defect detection and defect classification are organically connected, and may be dynamically updated or modified. Hereinafter, a method of detecting a defect by the defect detection model 220 is described.

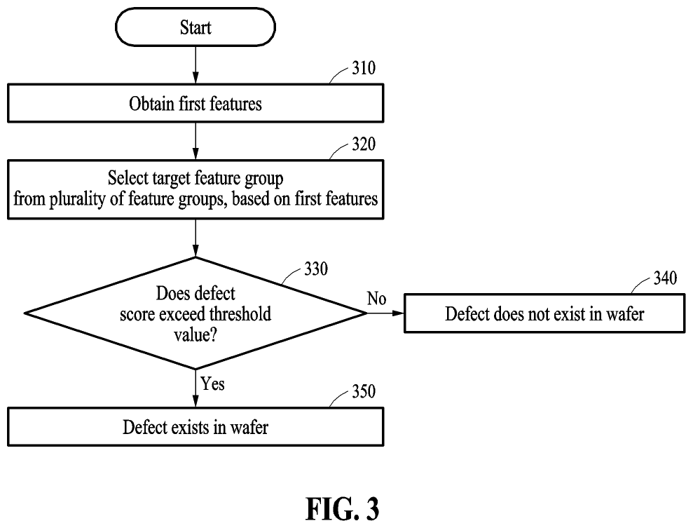

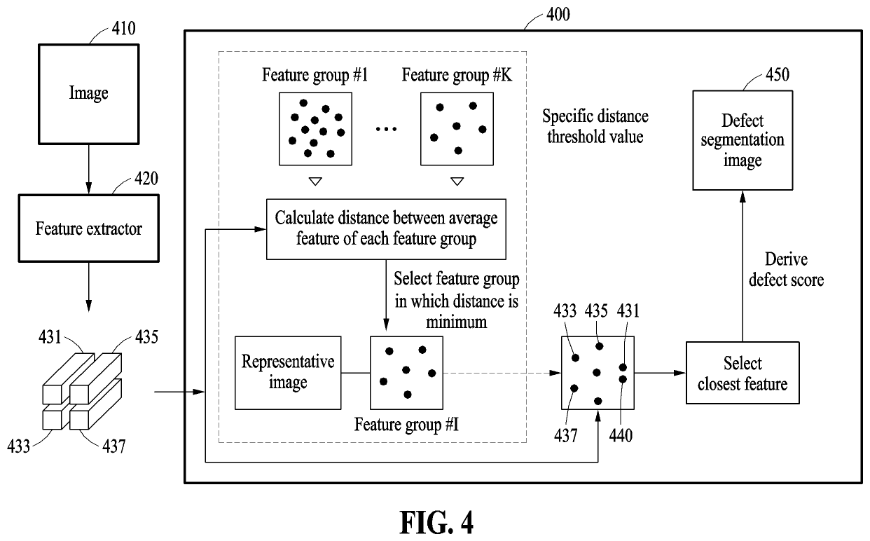

FIGS. 3 and 4 are diagrams illustrating a method of detecting a defect, according to an embodiment.

According to one or more embodiments of the disclosure, operations may be performed sequentially. However, the disclosure is not limited thereto. For example, according to an embodiment, the order of the operations may change. Also, according to an embodiment, at least two of the operations may be performed in parallel. Operations 310 to 350 may be performed by at least one component of an electronic device.

In operation 310, the method may include obtaining one or more first features. For example, a defect detection model may receive first features.

That is, the electronic device may input the first features into the defect detection model. Referring to FIG. 2, the defect detection model may receive the first features from a feature extractor. In an example case in which an image of a wafer is divided into a plurality of patches, the first features may be features extracted from one or more of the plurality of patches. For example, the first features may be features extracted from each of the plurality of patches when the image of the wafer is divided into the plurality of patches. For example, the first features may respectively correspond to the patches. In an example case in which an image is divided into four patches, four first features may be extracted and each first feature may correspond to one patch. However, the disclosure is not limited thereto, and as such, according to another embodiment, a number of patches and a number of first features may be different than four. Also, in another embodiment, a number of patches and a number of first features may be different from each other.

In operation 320, the method may include selecting a target feature group from a plurality of feature groups, based on the first features. For example, the defect detection model may select a target feature group from a plurality of feature groups, based on the first features.

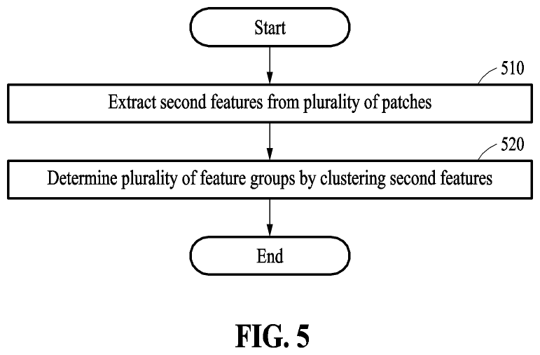

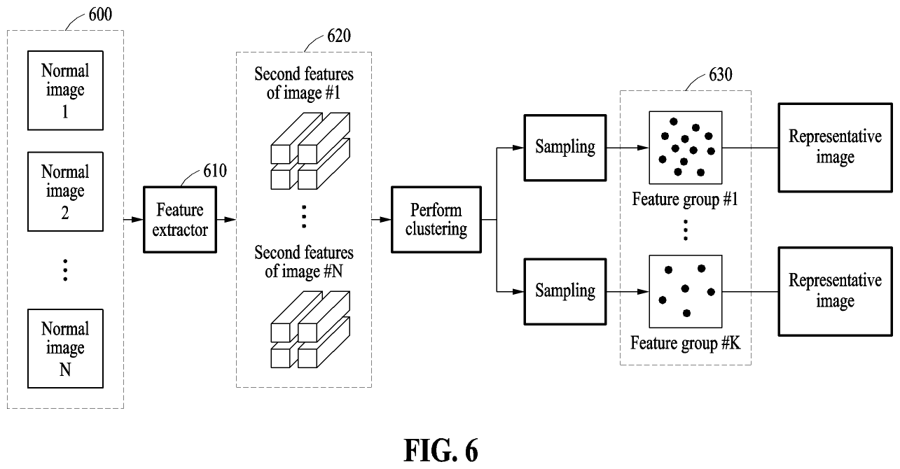

The plurality of feature groups may be obtained from a plurality of second images. The plurality of second images may be normal images or reference images. A method of obtaining the plurality of feature groups is described below with reference to FIGS. 5 and 6.

In operation 330, the method may include determining whether a defect score exceeds a reference value. For example, the defect detection model may determine whether a defect score exceeds a reference value. The reference value may be referred to as a threshold value.

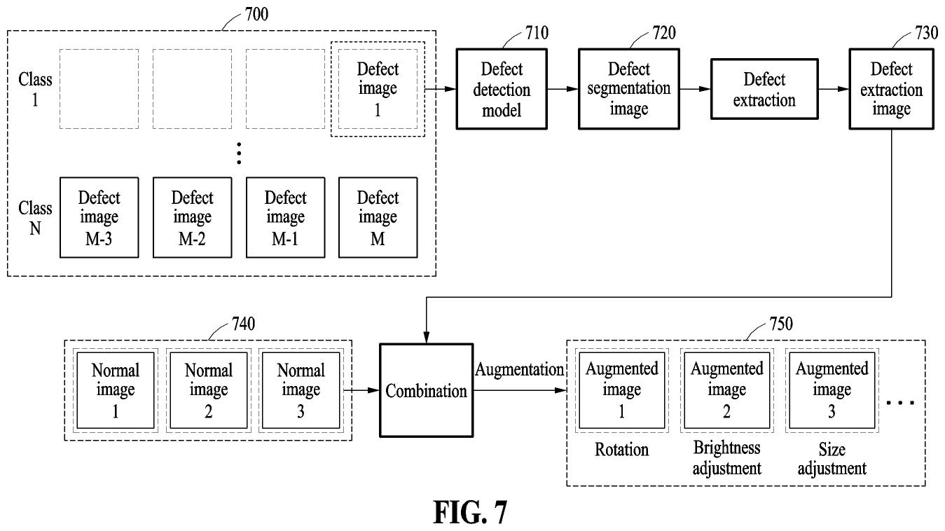

For example, the threshold value may be an optimal threshold value determined based on augmented images. For example, the augmented images may be generated by a method illustrated in FIG. 7. The defect detection model may determine the defect score based on the target feature group and the first features. The method of determining the defect score is described below with reference to FIG. 4 according to an embodiment.

In operation 340, the method may include determining that a defect does not exist (or a defect is not present) in at least a portion of the wafer included in the image based on a determination that the defect score is less than or equal to the threshold value. For example, the defect detection model may determine that a defect does not exist (or a defect is not present) in the wafer when the defect score does not exceed the threshold value. For example, the defect detection model may determine that a defect does not exist in at least a portion of the wafer included in the image when the defect score for each patch does not exceed the threshold value.

In operation 350, the method may include determining that a defect exists in the wafer included in the image based on the defect score for each patch being greater than the threshold value. For example, the defect detection model may determining that a defect exists in at least a portion of the wafer included in the image when the defect score for each patch exceeds the threshold value. For example, the defect detection model may determine that a defect exists in at least a portion of the wafer included in the image when the defect score for each patch exceeds the threshold value.

In an example case in which it is determined that a defect exists, the electronic device may input the image into a defect classification model to classify the defect.

Hereinafter, a method of selecting the target feature group and determining the existence of a defect based on the target feature group is described.

Referring to FIG. 4, a method of selecting a target feature group and calculating a defect score is illustrated.

According to an embodiment, the method may include performing a feature extraction process on an image 410. For example, the method may include inputting the image 410 into a feature extractor 420. For example, the electronic device may input an image 410 into a feature extractor 420. According to an embodiment, the method may include dividing the image 410 into a plurality of patches. For example, the electronic device may divide the image 410 into a plurality of patches and may input the image 410 to the feature extractor 420. According to an embodiment, the feature extractor 420 may divide the image 410 into a plurality of patches. According to an embodiment of the disclosure, for ease of description, it is assumed that the image 410 is divided into 2×2 patches. However, this is only an example, and as such, the disclosure is not limited thereto. According to another embodiment, the image 410 may be divided in another manner.

According to an embodiment, the method may include extracting a plurality of first features. For example, the feature extractor 420 may extract a plurality of first features 431, 433, 435, and 437. According to an embodiment, the method may include calculating an average feature for each of a plurality of feature groups (e.g., a feature group #1 to a feature group #K). For example, a defect detection model 400 may receive the plurality of first features 431, 433, 435, and 437 as input. The defect detection model 400 may calculate an average feature for each of a plurality of feature groups (e.g., a feature group #1 to a feature group #K). Each feature group may be matched with a representative image representing a corresponding feature group. According to an embodiment, a method of obtaining the plurality of feature groups is described below with reference to FIGS. 5 and 6.

According to an embodiment, the method may include determining a target feature group among the plurality of feature groups by calculating the distance between the average feature of each feature group and the first features 431, 433, 435, and 437. For example, the feature detection model 400 may determine a target feature group among the plurality of feature groups by calculating the distance between the average feature of each feature group and the first features 431, 433, 435, and 437. The feature detection model 400 may calculate the distance between the average feature of each feature group and the first features 431, 433, 435, and 437 and may determine a feature group with the closest distance as the target feature group. According to an embodiment, the Euclidean distance (e.g., L2 distance) may be used as the distance between features. However, this is only an example and the disclosure not limited thereto. As such, according to another embodiment, another distance calculation method may be used to calculate the distance between the average feature of each feature group and the first features 431, 433, 435, and 437.

In an example case in which one of the distances between the average feature of feature group #I and the first features 431, 433, 435, and 437 is the closest distance among the distances between the average feature of each feature group and the first features 431, 433, 435, and 437, feature group #I may be determined as the target feature group.

According to an embodiment, the method may include arranging the first features 431, 433, 435, and 437 in the target feature group. For example, the feature detection model 400 may arrange the first features 431, 433, 435, and 437 in the target feature group. According to an embodiment, the method may include determining a feature closest to any one of the first features 431, 433, 435, and 437 among the features included in a target feature group. For example, the feature detection model 400 may determine a feature closest to any one of the first features 431, 433, 435, and 437 among the features included in a target feature group. For example, the feature detection model 400 may determine a first feature that is closest to any one of the features included in the target feature among the first features 431, 433, 435, and 437. The features included in the target feature may be referred to as normal features. One or more of the normal features may correspond to at least a portion of the wafer without a defect. The first feature closest to any one of the features included in the target feature may be a feature closest to the normal feature among the first features 431, 433, 435, and 437. The L2 distance may be used to determine the closest feature. However, this is only an example and the disclosure is not limited thereto.

For example, since there are four first features 431, 433, 435, and 437, there may be four features included in the target feature group adjacent to each first feature. For example, four pairs of features may be determined. Each pair of features may include a first feature and a feature of the target feature group closest to the first feature. According to an embodiment, the method may include selecting a pair of features having the closest distance among the four pairs of features. For example, the feature detection model 400 may select a pair of features having the closest distance among the four pairs of features. For example, since the first feature 431 and a feature 440 have the closest distance, a pair of features including the first feature 431 and the feature 440 may be selected. For example, the first feature 431 may be a feature closest to the normal feature among the first features 431, 433, 435, and 437.

According to an embodiment, the method may include determining whether a defect has occurred using a determined feature and a first feature closest to the determined feature. For example, the feature detection model 400 may determine whether a defect has occurred using a determined feature and a first feature closest to the determined feature. In an example case in which a defect score of a first feature closest to the normal feature exceeds a threshold value, it may be determined that a defect exists in the image 410. For example, the feature detection model 400 may calculate the defect score based on the first feature 431 and the feature 440. The feature detection model 400 may determine that the defect has occurred when the defect score exceeds the threshold value. The feature detection model 400 may train the threshold value in a training operation. A method of training the threshold value is described below with reference to FIG. 7.

The defect score may be calculated in various methods. For example, the feature detection model 400 may use the distance between the first feature 431 and the feature 440 as the defect score. According to another embodiment, the feature detection model 400 may calculate an F1 score and accuracy based on the first feature 431 and the feature 440 to use the F1 score and the accuracy as the defect score. However, this is only an example and embodiments are not limited thereto.

According to an embodiment, the method may include outputting a defect segmentation image 450 based on a determination that a defect is present. In an example case in which it is determined that the defect exists, the feature detection model 400 may output a defect segmentation image 450 in which a defect portion of the image 410 is emphasized. The defect segmentation image 450 may be an image that visually represents a degree of the defect score of the first features 431, 433, 435, and 437.

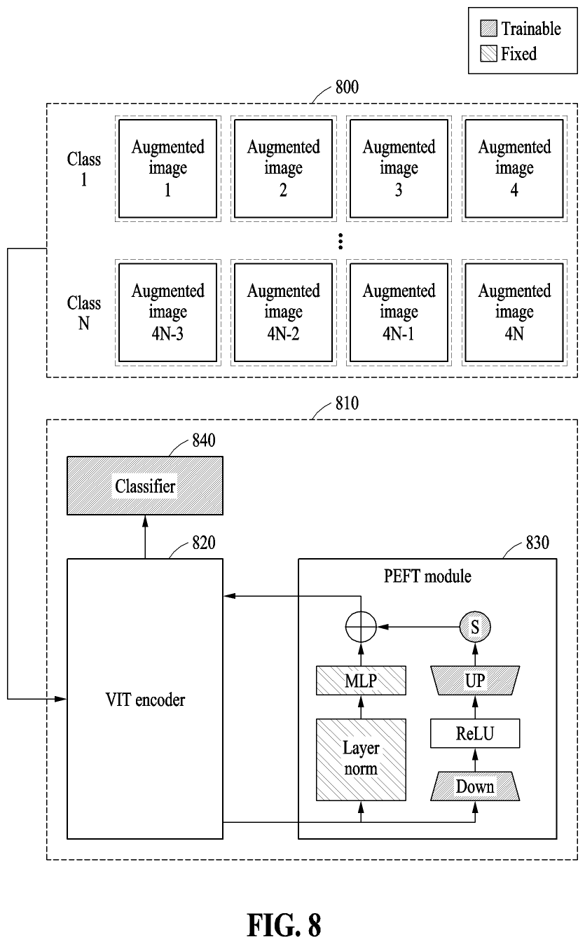

In an example case in which the feature detection model 400 determines that the defect exists in the image 410, the electronic device may input the image 410 into a defect classification model to determine the type of the defect. The defect classification model is described below with reference to FIG. 8.

Therefore, in order to detect a defect from an image and determine the type of the defect as shown in FIGS. 2 to 4, generation of a plurality of feature groups, training of a defect detection model, and training of a defect type model described with reference to FIGS. 5 to 8 may need to be performed in advance.

Hereinafter, the generation of a plurality of feature groups, the training of a defect detection model, and the training of a defect type model are described.

FIGS. 5 and 6 are diagrams illustrating a method of determining a plurality of feature groups, according to an embodiment.

According to one or more embodiments, operations may be performed sequentially but not necessarily. For example, the order of the operations may change and at least two of the operations may be performed in parallel. Operations 510 and 520 may be performed by any one or any combination of components of an electronic device.

In operation 510, the method may include extract second features from a plurality of patches. For example, the electronic device may extract second features from a plurality of patches. For example, the plurality of patches may be obtained by dividing each of the plurality of normal images.

The electronic device may input a plurality of normal images into a feature extractor. The electronic device may divide each of the plurality of normal images into a plurality of patches and may input the plurality of patches into the feature extractor. According to another embodiment, the feature extractor may divide each of the plurality of input normal images into a plurality of patches.

The feature extractor may extract features from the plurality of patches. In order to distinguish the features from the plurality of first features extracted from the target image described above with reference to FIGS. 2 to 4, the plurality of features extracted from the plurality of normal images may be referred to as a plurality of second features.

In operation 520, the method may include determining a plurality of feature groups by clustering the plurality of second features. For example, the electronic device may determine a plurality of feature groups by clustering the plurality of second features.

Referring to FIG. 6, a schematic diagram illustrating a method of determining a plurality of feature groups.

An electronic device may input a plurality of normal images 600 (that is, a normal image 1 to a normal image N) into a feature extractor 610. The plurality of normal images 600 may include at least a portion of a wafer without a defect. The plurality of normal images 600 may include at least a portion of a wafer captured at various magnifications and angles. For example, the plurality of normal images 600 may be normal images having various backgrounds.

The electronic device may divide each of the plurality of normal images 600 into a plurality of patches and may input the plurality of patches into the feature extractor 610. According to another embodiment, the feature extractor 610 may divide each of the plurality of input normal images 600 into a plurality of patches.

The feature extractor 610 may extract features from each of the plurality of patches. The plurality of patches being generated by dividing the plurality of normal images 600 are divided. That is, a plurality of second features 620 may be extracted.

The electronic device may perform clustering on the plurality of second features 620. The electronic device may perform clustering on the plurality of second features 620, may sample the plurality of second features 620 in a patch unit, and may group similar second features together. Accordingly, the electronic device may generate “K” feature groups 630. Each feature group may be matched with a representative image representing a corresponding feature group.

The plurality of feature groups 630 generated in the above-described method may be used when a target image is jointly detected as described above with reference to FIGS. 2 and 3.

Hereinafter, a method of generating a plurality of augmented images to train a defect detection model and a defect classification model is described.

FIG. 7 is a diagram illustrating a method of augmenting an image, according to an embodiment.

According to an embodiment, the method may include training a defect detection model and a defect classification model. For example, a plurality of defect images may be required to train a defect detection model and a defect classification model. A plurality of defect images 700 may include defect images of various classes. Each class may represent a different type of defect. For example, images included in the same class may be images including the same type of defect.

There may be an imbalance in the number of images between each class included in the plurality of defect images 700 (that is, a defect image 1 to a defect image M). For example, there may be an imbalance between the number of images included in class 1 and the number of images included in class N. Because of this imbalance, bias may occur when training the defect detection model and the defect classification model later. Therefore, hereinafter, a method of augmenting an image based on the plurality of defect images 700 is described. In addition, hereinafter, for ease of description, it is assumed that only the defect image 1 among the plurality of defect images 700 is input to a defect detection model 710. However, the disclosure is not limited thereto, and as such, a person of ordinary skill in the art would understand that the following descriptions may be equally applied to when all other defect images are input.

According to an embodiment, the method may include inputting a defect image 1 into a defect detection model 710. For example, an electronic device may input the defect image 1 into the defect detection model 710. Since the method of operating the defect detection model 710 is described above with reference to FIGS. 3 and 4, description thereof is omitted herein. However, unlike as shown in FIGS. 3 and 4, according to an embodiment, the defect detection model 710 may not use an optimal threshold value. For example, the defect detection model 710 may be a model trained based on non-augmented images (e.g., the plurality of defect images 700).

According to an embodiment, the method may include calculating a defect score from the defect image 1 and comparing the defect score with a reference value. For example, the defect detection model 710 may calculate a defect score from the defect image 1 and may compare the defect score with a reference value. The reference value may be a threshold value. However, the threshold value may not be an optimal threshold value as illustrated in FIGS. 3 and 4.

The defect detection model 710 may output a defect segmentation image 720 based on the input of the defect image 1. Since the description of the defect segmentation image 720 is provided above with reference to FIG. 4, description thereof is omitted. According to an embodiment of the disclosure, for ease of description, only one defect segmentation image 720 is shown. However, the disclosure is not limited thereto, and as such, a person of ordinary skill in the art would understand that defect segmentation images corresponding to the plurality of defect images 700 are output.

According to an embodiment, the method may include generating a defect extraction image 730 in which a portion of a defect is extracted from the defect image 1. For example, the electronic device may generate a defect extraction image 730 in which a portion of a defect is extracted from the defect image 1 based on the defect segmentation image 720. The defect extraction image 730 may be an image that includes a defect portion of the defect image 1 but the remaining portion has a pixel value of zero.

According to an embodiment, the method may include combining the defect extraction image 730 with a plurality of normal images 740 to augment the defect extraction image 730. For example, the electronic device may augment the defect extraction image 730 by combining the defect extraction image 730 with a plurality of normal images 740. According to an embodiment, the plurality of normal images 740 may be images used to generate a plurality of feature groups. For example, the plurality of feature groups may be generated based on one or more of the plurality of normal images 740.

According to an embodiment, the method may include generating a plurality of augmented images 750 by combining the plurality of normal images 740 with the defect extraction image 730. The plurality of augmented images 750 may have different characteristics. For example, the electronic device may generate a plurality of augmented images 750 by combining the plurality of normal images 740 with the defect extraction image 730 and then performing augmentation such as rotation, brightness adjustment, and size adjustment. The plurality of augmented images 750 may be images generated based on the defect extraction image 730 and may include the defect. Through augmentation, the imbalance between classes may be resolved.

The electronic device may train the defect detection model 710 using the plurality of augmented images 750 and the plurality of normal images 740. For example, the electronic device may update the defect detection model 710 based on the plurality of augmented images 750 and the plurality of normal images 740. For example, an optimal threshold to be compared with the defect score may be determined based on the plurality of augmented images 750 and the plurality of normal images 740.

The electronic device may input the plurality of augmented images 750 and the plurality of normal images 740 into the defect detection model 710. In an example case in which the electronic device inputs the plurality of augmented images 750 and the plurality of normal images 740 into the defect detection model 710, the electronic device may determine a threshold value at which a detection rate of the plurality of augmented images 750 is highest. Accordingly, the threshold value determined based on the plurality of augmented images 750 may be the optimal threshold value determined to best detect a defect. The threshold value may be determined differently for each feature group.

In addition, the electronic device may train a defect classification model using the plurality of augmented images 750. Hereinafter, a method of training the defect classification model using the plurality of augmented images 750 is described.

FIG. 8 is a diagram illustrating a defect classification model according to an embodiment.

According to an embodiment, an electronic device may input a plurality of augmented images 800 into a defect classification model 810. The plurality of augmented images 800 may be images augmented in the method of FIG. 7. Referring to FIG. 8, for ease of description, it is shown that there are four augmented images in each class. However, this is only an example, and as such, the disclosure is not limited thereto. According to another embodiment, the number of augmented images in each class may be different than four

The defect classification model 810 may include a vision transformer (VIT) encoder 820 based on a parameter efficient fine-tuning (PEFT) module 830 and a classifier 840.

The electronic device may input the plurality of augmented images 800 into the defect classification model 810 and may fine-tune parameters so that the defect classification model 810 may properly classify the plurality of augmented images 800 by class, to train the defect classification model 810. For example, the electronic device may train the defect classification model 810 by fine-tuning the parameters for trainable components among the components of the classifier 840 and the PEFT module 830.

In an example case in which the defect classification model 810 trained receives an image, as an input, including at least a portion of a wafer having a defect, the defect classification model 810 may classify the type of the defect. A type of defects may include various types. For example, a type of defects may include a type of a negligible defect that does not affect the performance of a semiconductor. For example, a type of defects may include a type of a defect that occurs due to an abnormality in a specific process. For example, a type of defects may include a type of a defect that occurs at a specific location on a wafer. However, this is only an example and embodiments are not limited thereto.

Accordingly, classification of types of defects may be used to improve a wafer yield.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specifically designed and constructed for the purposes of embodiments, or they may be of the kind well known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method comprising:
obtaining a first image of a wafer;
dividing the first image into a plurality of patches;
extracting one or more first features from the plurality of patches;
obtaining a plurality of feature groups by clustering one or more second features extracted from a plurality of second images;
selecting a target feature group from the plurality of feature groups, based on the one or more first features;
determining whether a defect is present in the wafer, based on the target feature group and the one or more first features; and
determining a defect type of the defect based on the defect being present in the wafer.

2. The method of claim 1, wherein the selecting of the target feature group from the plurality of feature groups comprises:
calculating an average feature of each of the plurality of feature groups; and
selecting the target feature group based on the one or more first features and the average feature of each of the plurality of feature groups.

3. The method of claim 2, wherein the selecting of the target feature group comprises:
calculating a distance between the one or more first features and the average feature of each of the plurality of feature groups, and
selecting, as the target feature group, a feature group in which the distance between the one or more first features and the average feature is a minimum.

4. The method of claim 1, wherein the determining of whether the defect is present in the wafer comprises:
determining a closest feature, which is a feature closest to one of the one or more first features among features of the target feature group; and
determining that the defect is present in the wafer based on a defect score corresponding to one of the one or more first features and the closest feature is greater than a threshold value.

5. The method of claim 4, wherein the threshold value is obtained based on a plurality of augmented images and the plurality of second images, and
the plurality of augmented images is obtained based on the plurality of second images and previously obtained defect images.

6. The method of claim 1, wherein the determining of the defect type of the defect comprises inputting the first image into a defect classification model trained based on the plurality of second images and a plurality of augmented images to determine the defect type of the defect, and
the plurality of augmented images is obtained based on the plurality of second images and previously obtained defect images.

7. The method of claim 1, wherein the determining of the plurality of feature groups comprises:
dividing each of the plurality of second images in a plurality of patches;
extracting the one or more second features from the plurality of patches; and
determining the plurality of feature groups by clustering the one or more second features.

8. The method of claim 7, further comprising:
determining a threshold value to determine whether the defect is present based on the plurality of feature groups.

9. The method of claim 8, wherein the determining of the threshold value comprises:
extracting defect portions from previously obtained defect images;
generating combined images by combining the plurality of second images with the defect portions;
generating a plurality of augmented images by augmenting the combined images; and
determining the threshold value based on the plurality of augmented images.

10. A non-transitory computer-readable storage medium storing instructions that, when executed by a processor, cause the processor to perform the method of claim 1.

11. A method comprising:
determining a plurality of feature groups, based on a plurality of first images;
obtaining a plurality of augmented images based on the plurality of first images and previously obtained defect images;
obtaining a second image for a wafer;
determining a threshold value of a defect detection model for detecting a defect in the wafer included in the second image, based on the plurality of first images and the plurality of augmented images;
determining whether the defect is present in the wafer by inputting the second image into the defect detection model for detecting the defect based on the threshold value; and
determining a defect type of the defect by inputting the second image into a defect classification model based on the defect being present.

12. The method of claim 11, further comprising:
generating the plurality of augmented images based on the plurality of first images,
wherein the generating of the plurality of augmented images comprises:
extracting defect portions from the previously obtained defect images;
generating combined images by combining the plurality of first images with the defect portions; and
generating the plurality of augmented images by augmenting the combined images.

13. The method of claim 12, wherein the determining of the threshold value comprises determining, as the threshold value, a value with a highest detection rate for an image of a wafer in which a defect is present based on the plurality of augmented images and the plurality of first images input to the defect detection model.

14. The method of claim 11, wherein the determining of whether the defect is present comprises:
dividing the second image into a plurality of patches;
extracting one or more first features from the plurality of patches;
selecting a target feature group from a plurality of feature groups obtained based on the plurality of first images, based on the one or more first features; and
determining whether the defect is present in the wafer, based on the target feature group and the one or more first features.

15. The method of claim 14, wherein the selecting of the target feature group from the plurality of feature groups comprises:
calculating a distance between the one or more first features and an average feature of each of the plurality of feature groups and selecting a feature group in which the distance is a minimum as the target feature group.

16. The method of claim 14, wherein the determining of whether the defect is present comprises:
determining a closest feature, which is a feature closest to one of the one or more first features among features of the target feature group; and
determining that the defect is present in the wafer based on a defect score corresponding to one of the one or more first features and the closest feature being greater than the threshold value.

17. An electronic device comprising:
a processor configured to:
obtain a first image of a wafer;
divide the first image into a plurality of patches;
extract one or more first features from the plurality of patches;
obtain a plurality of feature groups by clustering one or more second features extracted from a plurality of second images;
select a target feature group from the plurality of feature groups, based on the one or more first features;
determine whether a defect is present in the wafer, based on the target feature group and the one or more first features; and
determine a defect type of the defect based on the defect being present in the wafer.

18. The electronic device of claim 17, wherein the processor is further configured to:
calculate an average feature of each of the plurality of feature groups, and
select the target feature group based on the one or more first features and the average feature of each of the plurality of feature groups.

19. The electronic device of claim 17, wherein the processor is further configured to:
determine a closest feature, which is a feature closest to one of the one or more first features among features included in the target feature group, and
determine that the defect is present in the wafer based on a defect score corresponding to one of the one or more first features and the closest feature is greater than a threshold value.

20. The electronic device of claim 17, wherein the processor is further configured to input the first image into a defect classification model trained based on the plurality of second images and a plurality of augmented images to classify the defect type of the defect, and
the plurality of augmented images is obtained based on the plurality of second images and previously obtained defect images.
